(19) United States
(12) Patent Application Publication
(10) Pub. No.: US 2012/0113035 A1
(43) Pub. Date: May 10, 2012

(54) DETECTION METHOD AND DETECTION DEVICE FOR DETECTING MULTIPLE CONTACTS ON TOUCH PANEL ACCORDING PRELIMINARY SENSING DATA

(76) Inventor: Tung-Ke Wu, Taipei City (TW)

(21) Appl. No.: 13/288,974

(22) Filed: Nov. 4, 2011

(30) Foreign Application Priority Data
Nov. 4, 2010 (TW) 099137929

(51) Int. Cl. G06F 3/041

(52) U.S. Cl. 345/173

(57) ABSTRACT

A detection method for detecting a plurality of contacts on a touch panel including a plurality of first sensing axes on a first dimension and a plurality of second sensing axes on a second dimension, includes: generating a preliminary sensing data according to the contacts on the touch panel; determining a plurality of first specific sensing axes included in the plurality of first sensing axes and a plurality of f second specific sensing axes included in the plurality of second sensing axes according to the preliminary sensing data; driving the plurality first specific sensing axes one-by-one; obtaining a first sensing data by respectively receiving a sensing data corresponding to each of the plurality first specific sensing axes from the plurality of second sensing axes of the touch panel; and determining the plurality of contacts according to at least the first sensing data.

### BACKGROUND OF THE INVENTION

1. Field of the Invention

The disclosed embodiments of the present invention relate to a contact detection scheme, and more particularly, to a detection method and detection device for detecting a plurality of contacts on a touch panel.

2. Description of the Prior Art

In a regular mutual capacitance touch panel, there are two common detection methods. The first detection method is orderly driving all sensing axis on a first dimension (e.g., X axis) on a touch panel and then orderly receiving a sensing signal corresponding each sensing axis on X axis through each sensing axis on a second dimension (e.g., Y axis), and then orderly driving each sensing axis on Y axis and orderly receive a sensing signal corresponding to each sensing axis on Y axis through each sensing axis on X axis. For example, please refer to FIG. 1, which is a schematic diagram of a conventional touch panel 100 detecting multiple contacts TP1, TP2 and TP3. As can be known from the figure, the conventional touch panel 100 has 8 sensing axes X1-X8 and Y1-Y8 on X axis and Y axis, respectively, sensing signals corresponding to Y axis that are received on X axis are represented by SX, and sensing signals corresponding to X axis that are received on Y axis are represented by SY. The advantage of employing the first detection method is that the overall detection process is very fast. The detection process mainly includes the operations of driving and receiving, and the number of receiving operations will be at most 16 and at least 2, depending on the number of analog-to-digital converters (ADCs) included in the touch panel 100. But the shortcoming is that, contacts on the same receiving axis can not be distinctively recognized. Please refer to FIG. 1 again. In FIG. 1, due to the fact that contacts TP1 and TP2 are parallel with each other in the direction of X axis, and the contacts TP2 and TP3 are parallel with each other in the direction of Y axis, the conventional touch panel 100 would additionally detect a non-existing contact TP′ besides the contacts TP1, TP2 and TP3, resulting in an incorrect detection.

The second detection method is to drive each of the sensing axes on X axis of the conventional touch panel one-by-one, and respectively receive sensing signals corresponding to each of the sensing axes on X axis from each of the sensing axes on Y axis, or to drive each of the sensing axes on Y axis of the conventional touch panel one-by-one, and respectively receive sensing signals corresponding to each of the sensing axes on Y axis from each of the sensing axes on X axis. The second detection method can effectively and precisely locate every contact without any wrong decision. However, the second detection method would have the shortcoming of having a significantly increased number of scan operations when compared to the first detection method. Taking conventional touch panel 100 shown in FIG. 1 for example, there are 8 sensing axes on X axis and Y axis, respectively, and each sensing axis needs to send and receive a signal once. Thus, the number of scan operations will be at most 8*8=64 and at least 8, depending on the number of ADCs used. Compared to the first detection method which only requires 2-16 scan operations, the second detection method needs more processing time, especially for a large-sized touch panel. Specifically, the number of scan operations would be rapidly increased along with the increase of the size of the touch panel. For a touch panel with 32 sensing axes on X axis and 20 sensing axes on Y axis, the number of scan operations required is significantly increased to be 32*20=640. As a result, using the second detection method would significantly lower the response speed of the touch panel.

### SUMMARY OF THE INVENTION

In accordance with exemplary embodiments of the present invention, a detection method and detection device for detecting a plurality of contacts utilizing a preliminary detection data are proposed to solve the above-mentioned problem. The detection method and detection device are capable of rapidly accomplishing the touch event detection and greatly reducing the number of scan operations required by the touch event detection.

According to a first aspect of the present invention, an exemplary detection method for detecting a plurality of contacts on a touch panel is disclosed. The touch panel includes a plurality of first sensing axes on a first dimension and a plurality of second sensing axes on a second dimension. The exemplary detection method includes: generating a preliminary sensing data according to the contacts on the touch panel; determining a plurality of first specific sensing axes included in the plurality of first sensing axes and a plurality off second specific sensing axes included in the plurality of second sensing axes according to the preliminary sensing data; driving the plurality first specific sensing axes one-by-one; obtaining a first sensing data by respectively receiving a sensing data corresponding to each of the plurality first specific sensing axes from the plurality of second sensing axes of the touch panel; and determining the plurality of contacts according to at least the first sensing data.

According to a second aspect of the present invention, an exemplary detection device for detecting a plurality of contacts on a touch panel is disclosed. The touch panel includes a plurality of first sensing axes on a first dimension and a plurality of second sensing axes on a second dimension. The exemplary detection device includes a preliminary detection circuit, a sensing axis selection circuit, an advanced detection circuit and a determining circuit. The preliminary detection circuit is for generating a preliminary sensing data according to the plurality of contacts on the touch panel. The sensing axis selection circuit is coupled to preliminary detection circuit, for determining a plurality first specific sensing axes in the plurality of first sensing axes and a plurality second specific sensing axes in the plurality of second sensing axes according to the preliminary sensing data. The advanced detection circuit is coupled to the sensing axis selection circuit, for driving the plurality of first specific sensing axes one-by-one, and obtaining a first sensing data by respectively receiving a sensing data corresponding to each of the plurality of first specific sensing axes from the plurality of second specific sensing axes of the touch panel. The determining circuit is coupled to the advanced detection circuit, for determining the plurality of contacts according to at least the first sensing data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional touch panel detecting multiple contacts.

FIG. 2 is a schematic diagram of a detection device applied to a touch panel according to an embodiment of the present invention.

FIG. 3 is a schematic diagram of a detection operation performed on a touch panel according to an embodiment of the present invention.

FIG. 4 is a schematic diagram of a detection operation performed on a touch panel according to another embodiment of the present invention.

### DETAILED DESCRIPTION

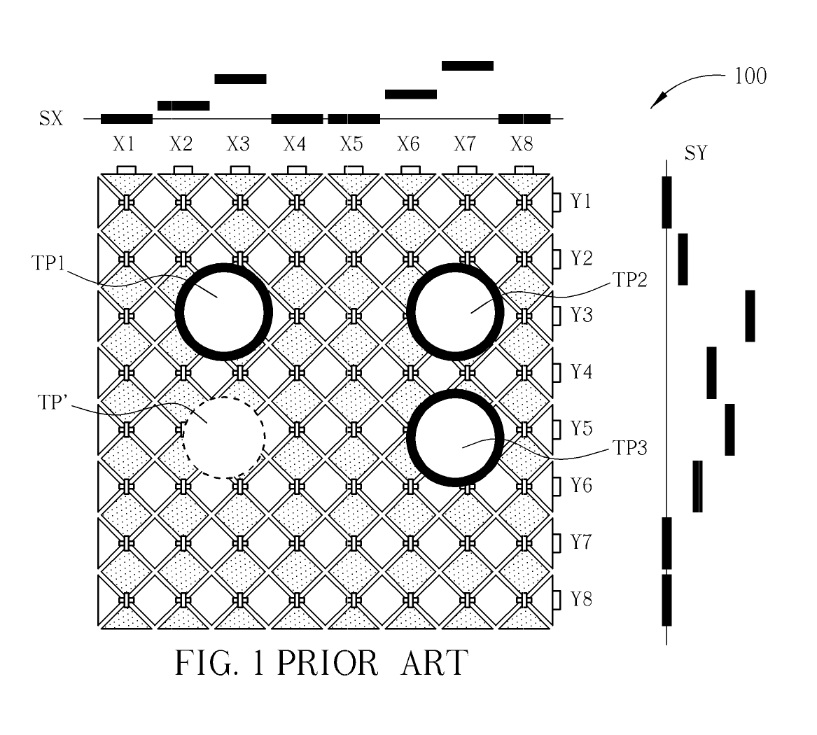

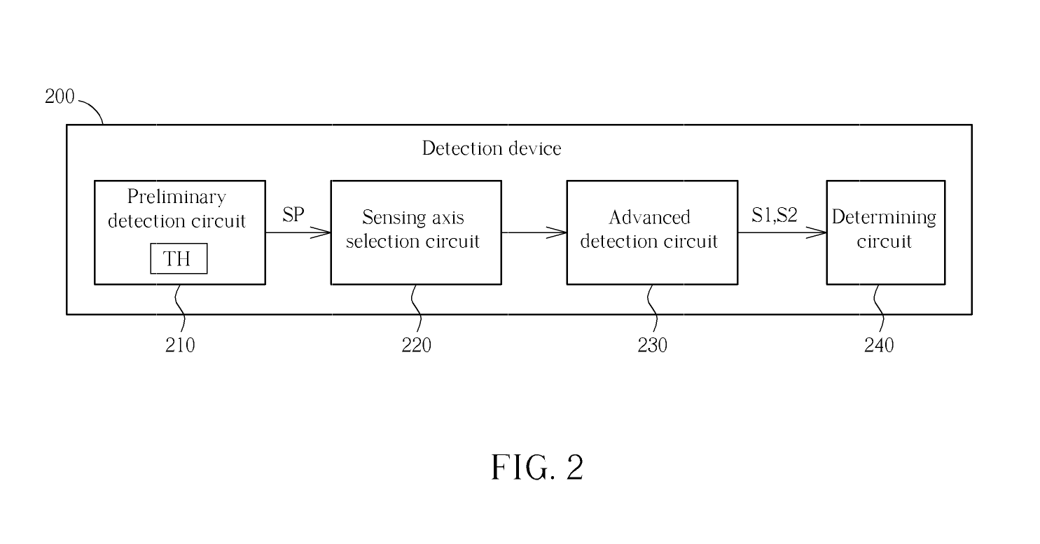

Please refer to FIG. 2, which is a schematic diagram of a detection device 200 applied to a touch panel 100 according to an embodiment of the present invention. The touch panel 100 includes a plurality of first sensing axes on a first dimension (e.g., X axis), and includes a plurality of second sensing axes on a second dimension, (e.g., Y axis). For example, the detection device 200 is applied to the touch panel 100 shown in FIG. 1 to detect contacts thereon, wherein the touch panel 100 has a plurality of first sensing axes X1-X8 and a plurality of second sensing axes Y1-Y8. In this embodiment, the detection device 300 includes (but not limited to) a preliminary detection circuit 210, a sensing axis selection circuit 220, an advanced detection circuit 230 and a determining circuit 240. First, the preliminary detection circuit 210 would generate a preliminary sensing data SP according to all contacts on the touch panel. For example, the preliminary detection circuit 210 first concurrently drives the first sensing axes X1-X8 of the touch panel 100, and receives corresponding sensing signal SY on the second sensing axes Y1-Y8 of the touch panel 100; next, the preliminary detection circuit 210 concurrently drives the second sensing axes Y1-Y8, and receives corresponding sensing signal SX on the first sensing axes X1-X8; and finally, the preliminary sensing data SP is generated according to the sensing signal SY and the sensing signal SX. As can be known from FIG. 1, the sensing signal SX indicates that only first sensing axes X2, X3, X6 and X7 among the first sensing axes have response signals, and the sensing signal SY indicates that only second sensing axes Y2, Y3, Y4, Y5 and Y6 among the second sensing axes have response signals. Therefore, the sensing axis selection circuit 220 determines a first specific sensing axis and a second specific sensing axis according to the sensing axes having response signals in the preliminary sensing data SP.

In one embodiment, the sensing axis selection circuit 220 determines a plurality of first specific sensing axes in the first sensing axes X1-X8 (i.e., the first sensing axes X2, X3, X6 and X7) and a plurality of second specific sensing axes in the second sensing axes Y1-Y8 (i.e., the second sensing axes Y2, Y3, Y4, Y5 and Y6). Please note that, this is for illustrative purposes only and not meant to be limitations of the present invention. In another embodiment, the preliminary sensing data SP includes a first preliminary sensing data and a second preliminary sensing data, wherein the preliminary detection circuit 210 concurrently drives a plurality of first sensing axes, and respectively receives a first sensing data corresponding to each of the first sensing axes on a plurality of second sensing axes (e.g., the first sensing axes are X1 -X8, and the second sensing axes are Y1-Y8; alternatively, if the first sensing axes are Y1-Y8, the second sensing axes are X1-X8) to thereby generate the first preliminary sensing data, and concurrently drives these second sensing axes, and respectively receives a second sensing data corresponding to each of the second sensing axes on these first sensing axes to thereby generate the second preliminary sensing data. In addition, the preliminary detection circuit 210 further performs a selection operation of sensing data to lower the possibility of misjudgment. For example, the preliminary detection circuit 210 generates the first preliminary sensing data according to each first sensing data exceeding a threshold value TH, and/or generates the second preliminary sensing data according to each second sensing data exceeding the threshold value TH.

After these specific sensing axes are determined, the advanced detection circuit 230 drives the first specific sensing axes X2, X3, X6 and X7 one-by-one, and obtains a first sensing data S1 by respectively receiving a sensing data corresponding to each of the plurality first specific sensing axes (i.e., X2, X3, X6 and X7) from the plurality of second sensing axes Y2-Y6 of the touch panel 100. Next, the advanced detection circuit 230 drives the plurality second specific sensing axes one-by-one, and obtains a second sensing data S2 by respectively receiving a sensing data corresponding to each of the plurality second specific sensing axes (i.e., Y2-Y6) from the plurality of first sensing axes X2, X3, X6 and X7 of the touch panel 100.

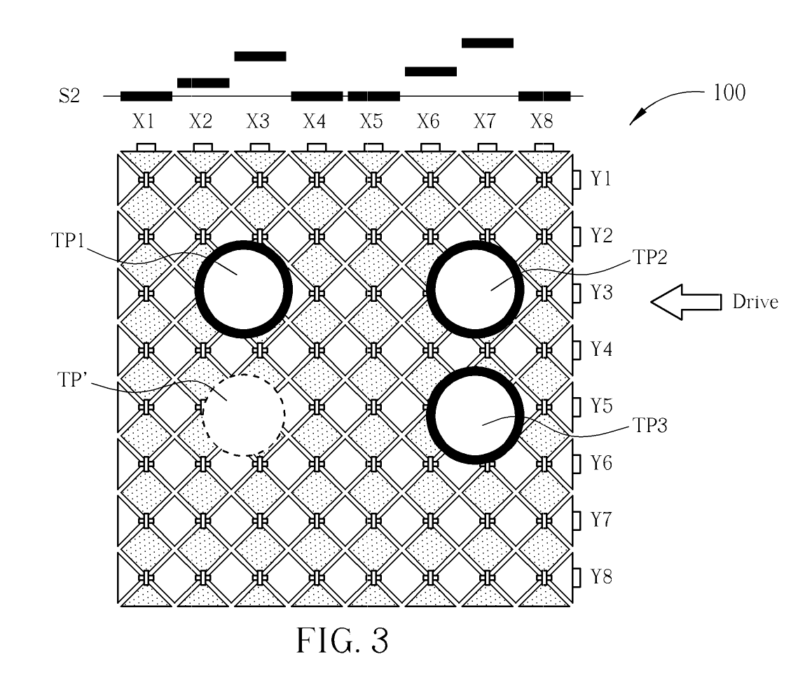

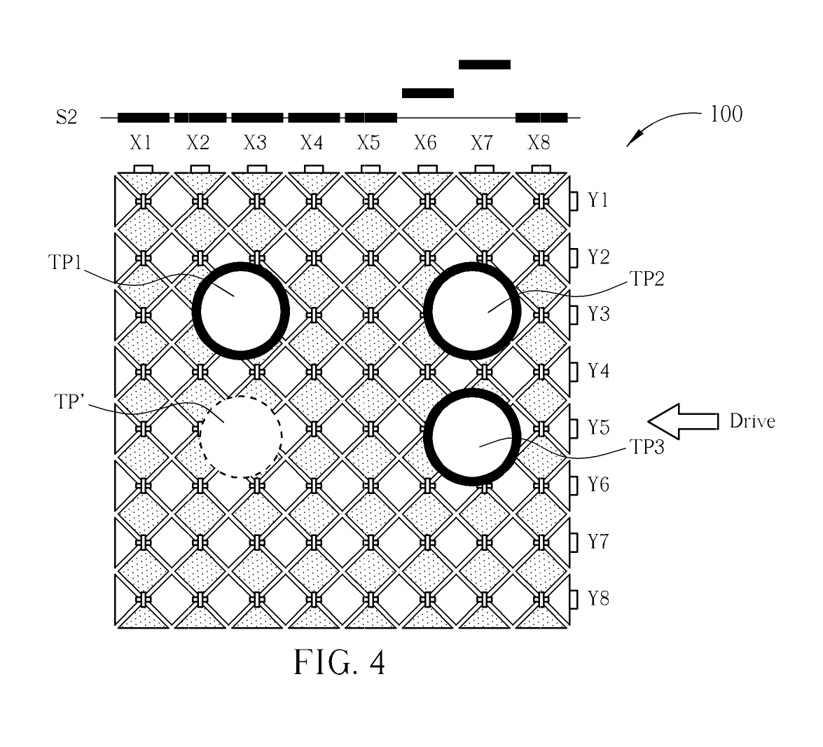

Please refer to FIG. 3, which is a schematic diagram of a detection operation performed on a touch panel according to an embodiment of the present invention. Since the first sensing axes X2, X3, X6 and X7 have response signals when the second sensing axis Y3 is driven, the determine circuit 240 can determine that there are contacts at the intersections of the second sensing axis Y3 and the first sensing axes X2, X3, X6 and X7, i.e., contacts TP1 and TP2. Please refer to FIG. 4, which is a schematic diagram of a detection operation performed on a touch panel according to another embodiment of the present invention. Since only the first sensing axes X6, X7 have response signals when the second sensing axis Y5 is driven, the determine circuit 240 determines that there are contacts at the intersections of the second sensing axis Y5 and the first sensing axes X6 and X7, and since the first sensing axes X2 and X3 present no corresponding response signals, the determine circuit 240 will not determine that there are contacts at the intersections of the second sensing axis Y5 and the first sensing axes X2 and X3. In this way, the contact TP′ can be prevented from being misjudged as an actual contact. Please note that, in this embodiment, the determine circuit 240 concurrently uses the first sensing data S1 and the second sensing data S2 to determine the contacts. However, the determine circuit 240 can only use the first sensing data S1/the second sensing data S2 to determine whether there are duplicate/misjudged contacts on the plurality of second sensing axes/the plurality of first sensing axes. This alternative design also falls in the scope of the present invention.

With the use of the aforementioned exemplary detection method, the detection device 200 can utilize the preliminary detection circuit 210 to scan the touch panel 100 16 times to generate the preliminary sensing data SP; besides, the detection device 200 can utilize the advanced detection circuit 230 to scan the specific sensing axes (e.g., X2, X3, X6 and X7, and Y2-Y6) included in the sensing axes, leading to a corresponding number of scan operations equal to 4*5=20. As mentioned in the background section, the conventional method for precisely locating the contacts (i.e., the second detection method mentioned in the background section) needs to scan the touch panel 100 64 times. However, compared with the conventional method, the present invention only needs to scan 16+20=36 times. The present invention can significantly lower the scan time needed, and thereby greatly improve overall performance of a touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A detection method for detecting a plurality of contacts on a touch panel, the touch panel comprising a plurality of first sensing axes on a first dimension and a plurality of second sensing axes on a second dimension, the detection method comprising:
generating a preliminary sensing data according to the contacts on the touch panel;
determining a plurality of first specific sensing axes included in the plurality of first sensing axes and a plurality off second specific sensing axes included in the plurality of second sensing axes according to the preliminary sensing data;
driving the plurality first specific sensing axes one-by-one;
obtaining a first sensing data by respectively receiving a sensing data corresponding to each of the plurality first specific sensing axes from the plurality of second sensing axes of the touch panel; and
determining the plurality of contacts according to at least the first sensing data.

2. The detection method of claim 1, further comprising:
driving the plurality second specific sensing axes one-by-one; and
obtaining a second sensing data by respectively receiving a sensing data corresponding to each of the plurality second specific sensing axes from the plurality of first sensing axes of the touch panel;
wherein the step of determining the plurality of contacts comprises:
determining the plurality of contacts according to the first sensing data and the second sensing data.

3. The detection method of claim 1, wherein the preliminary sensing data comprises a first preliminary sensing data and a second preliminary sensing data, the plurality first specific sensing axes are selected from the plurality of first sensing axes based on the first preliminary sensing data, the plurality second specific sensing axes are selected from the plurality of second sensing axes based on the second preliminary sensing data, and the step of generating the preliminary sensing data comprises:
concurrently driving the plurality of first sensing axes, and generating the first preliminary sensing data by respectively receiving a first sensing data corresponding to each of the plurality first sensing axes from the plurality of second sensing axes; and
concurrently driving the plurality of second sensing axes, and generating the second preliminary sensing data by respectively receiving a second sensing data corresponding to each of the plurality second sensing axes from the plurality of first sensing axes.

4. The detection method of claim 3, wherein the step of generating the first preliminary sensing data comprises:
generating the first preliminary sensing data according to first sensing data each exceeding a threshold value.

5. The detection method of claim 4, wherein the step of generating the second preliminary sensing data comprises:
generating the second preliminary sensing data according to second sensing data each exceeding the threshold value.

6. A detection device for detecting a plurality of contacts on a touch panel, the touch panel comprising a plurality of first sensing axes on a first dimension and a plurality of second sensing axes on a second dimension, the detection device comprising:
a preliminary detection circuit, for generating a preliminary sensing data according to the plurality of contacts on the touch panel;
a sensing axis selection circuit, coupled to preliminary detection circuit, for determining a plurality first specific sensing axes in the plurality of first sensing axes and a plurality second specific sensing axes in the plurality of second sensing axes according to the preliminary sensing data;
an advanced detection circuit, coupled to the sensing axis selection circuit, for driving the plurality of first specific sensing axes one-by-one, and obtaining a first sensing data by respectively receiving a sensing data corresponding to each of the plurality of first specific sensing axes from the plurality of second specific sensing axes of the touch panel; and
a determining circuit, coupled to the advanced detection circuit, for determining the plurality of contacts according to at least the first sensing data.

7. The detection device of claim 6, wherein the advanced detection circuit further drives the plurality of second specific sensing axes one-by-one, and obtains a second sensing data by respectively receiving a sensing data corresponding to each of the plurality of second specific sensing axes from the plurality of first specific sensing axes of the touch panel; and the determining circuit determines the plurality of contacts according to the first sensing data and the second sensing data.

8. The detection device of claim 6, wherein:
the preliminary sensing data comprises a first preliminary sensing data and a second preliminary sensing data;
the sensing axis selection circuit selects the plurality first specific sensing axes from the plurality of first sensing axes based on the first preliminary sensing data, and selects the plurality second specific sensing axes from the plurality of second sensing axes based on the second preliminary sensing data;
the preliminary detection circuit concurrently drives the plurality of first sensing axes, and generates the first preliminary sensing data by respectively receiving a first sensing data corresponding to each of the plurality of first sensing axes from the plurality of second sensing axes; and
the preliminary detection circuit concurrently drives the plurality of second sensing axes, and generates the second preliminary sensing data by respectively receiving a second sensing data corresponding to each of the plurality of second sensing axes from the plurality of first sensing axes.

9. The detection device of claim 8, wherein the preliminary detection circuit generates the first preliminary sensing data according to first sensing data each exceeding a threshold value.

10. The detection device of claim 9, wherein the preliminary detection circuit further generates the second preliminary sensing data according to second sensing data each exceeding the threshold value.
